(19) United States
(12) Patent Application Publication
(10) Pub. No.: US 2008/0119294 A1
(43) Pub. Date: May 22, 2008

(54) Oldham Coupling with Damping

(76) Inventors: Kenneth W. Erikson, Amherst, NH (US); Keith W. Erikson, Hollis, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/560,675

(22) Filed: Nov. 16, 2006

(51) Int. Cl. F16D 3/04

(52) U.S. Cl. 464/104

(57) ABSTRACT

An improved Oldham coupling that is a unitary object and in an embodiment comprises a first hub having a first projection and a second hub having a second projection. The two hubs are connected to each other by way of an intermediate disk having a first slot and a second slot, the slots being on opposite sides and perpendicular to each other. The first projection is received into the first slot and the second projection is received into the second slot. Elastomeric material is formed around the circumference of the disk to retain the assembly together as a unitary object.

### BACKGROUND

An Oldham coupling is used for connecting two shafts that are parallel, but may not be in perfect alignment. The Oldham coupling is particularly suited to joining shafts where one is a driving member and the other a driven member.

There are two general types of Oldham couplings, both sharing several basic components. Oldham couplings generally comprise two hubs fitted onto the ends of two shafts and joined together by at least one intermediate member. Each hub typically has a slot or groove.

The first type of Oldham coupling has an intermediate member comprising a floating member shaped as a disk. The disk has a projection or slot on each side, positioned perpendicular to each other. Each hub has a matching slot or projection to the disk. When assembled, two degrees of freedom are allowed, accommodating radial misalignment (where the driving and driven shafts are parallel but displaced with respect to their axial centers). Typically, radial misalignment up to 5% of the shaft diameter can be accommodated. Only one degree of angular misalignment is generally handled (where the axial centers of the driving and driven shafts intersect).

The second type of Oldham coupling has an intermediate member comprising a floating member shaped as a square block. The square block is adapted to fit between matching perpendicular slots of the two hubs, similarly providing two degrees of freedom to accommodate radial misalignment when the hubs and disk are assembled. This type of Oldham coupling typically compensates for radial misalignments as high as 10% of the shaft diameter. Three degrees of angular misalignment are also handled.

### SUMMARY

A disadvantage of known Oldham coupling designs is that such designs do not accommodate large angular misalignment and can be difficult to install in many cases. There is a need for an improved Oldham coupling which overcomes or substantially reduces the problems of the prior art.

The present invention provides an Oldham coupling assembly for connecting two shafts, where the coupling, as assembled, is one unitary piece. The assembly according to one embodiment includes a first hub having a first projection; a second hub having a second projection; an intermediate disk having a first and second slot, the slots on opposite sides of the disk and perpendicular to each other, the first projection received into the first slot and the second projection received into the second slot; and an elastomeric material formed around the circumference of the disk to retain the assembly together. In another embodiment, the hubs have slots and the disk has projections.

Another aspect is a method for making the assembly, including: joining first and second hubs to opposite sides of an intermediate disk; and forming an elastomeric material around the circumference of the disk to retain the assembly together.

Use of the unitary piece design of the present invention in actuator applications allows a coupling to be mounted without the motor. In addition, dampening aspects of embodiments help to reduce vibration transmission from the motor.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a side perspective view of an embodiment of the Oldham coupling of the present invention in assembly without elastomeric material;

FIGS. 2A-2B are exploded perspective views of the embodiment of FIG. 1;

FIG. 3 is a side view of the embodiment of FIG. 1 with elastomeric material;

FIG. 4 is a cross-sectional view of an embodiment of the disk of the present invention with elastomeric material;

FIG. 5 is a side perspective view of the embodiment of FIG. 1, illustrating radial misalignment.

### DETAILED DESCRIPTION

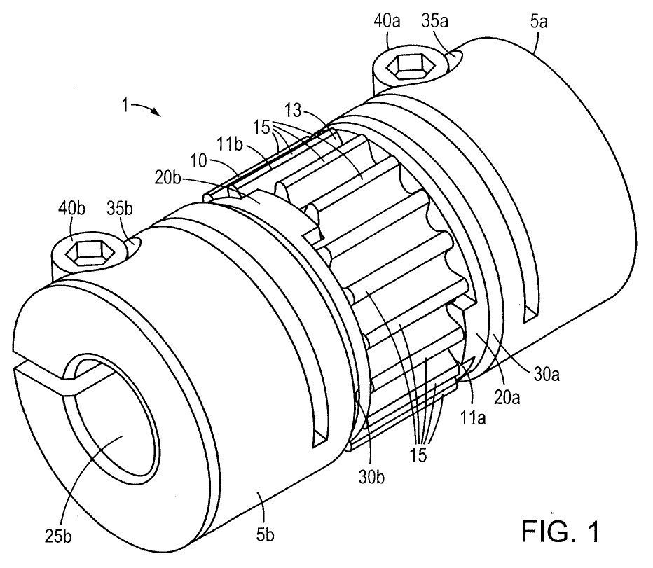

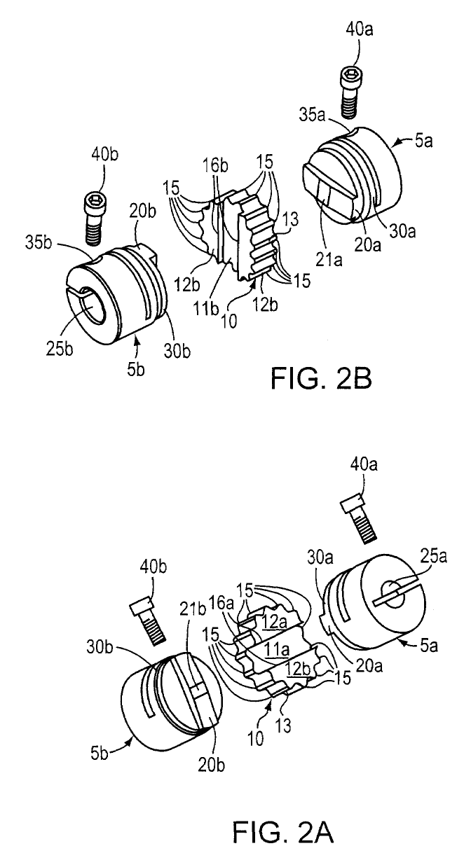

FIG. 1 shows an embodiment of an Oldham coupling of the present invention in assembly without elastomeric material. Coupling 1, designed in accordance with the present invention, includes two hubs, 5a and 5b, and an intermediate disk 10. Hub 5a includes a projection 20a, and a circumferential notch 30a. Hub 5a further has slot 25a (shown in FIG. 2A) adapted to either a driving or driven shaft, such a shaft being secured thereto by suitable means such as screw 40a. Hub 5b is similar to hub 5a, having projection 20b, a circumferential notch 30b, slot 25b, and screw 40b. Projection 20b is rotated 90 degrees with respect to projection 20a. Hubs 5a and 5b are coupled by way of intermediate disk 10 provided with surface 12a (shown in FIG. 2A) including slot 11a and surface 12b (shown in FIG. 2B) including slot 11b. Slot 11a and slot 11b are mutually perpendicular and are adapted to receive projection 20a and 20b, respectively.

In the preferred embodiment, surface 13 of disk 10 is characterized by splines 15. In other embodiments, surface 13 can be smooth, have cavities, or have slots, or disk 10 can have a larger or smaller diameter than hubs 5a and 5b. In yet other embodiments, the hubs 5a, 5b have slots rather than projections, and the disk 10 has projections rather than slots, with the slots and projections engaging in a similar manner as described above.

More specifically, referring to FIGS. 2A and 2B, in the preferred embodiment, projections 20a and 20b are essentially rectangular with the side facing disk 10 being tapered away from flat bearing surfaces 21a and 21b. Projections 20a and 20b are preferably dimensioned to have a width about 25% of the length. Surfaces 12a and 12b are preferably flat. Optionally, projections 20a and 20b may be tapered from any point along their surfaces, with the more the taper, the more the angular misalignment compensation provided. Slots 11a and 11b preferably have a flat bottom. In one embodiment, slot 11a has a small raised surface 16a in either side wall for the purpose of alignment for injection molding. Likewise, slot 11b has raised surfaces 16b. When slot 11a is engaged with projection 20a, flat bearing surface 21a is in contact with slot 11a, creating space between slot 11a and the tapered portions of projection 20a to allow for an amount of angular misalignment as discussed further herein. Slot 11b and projection 20b engage in the same manner.

In the preferred embodiment, splines 15 fully encompass surface 13 of disk 10, splines 15 having an essentially cylindrical shape. The height of the splines 15 may vary and help to guide material flow during injection molding.

Hubs 5a and 5b and disk 10 optionally can be of the same or different material. Examples of possible materials includes: aluminum, aluminum alloy, anodized aluminum, stainless steel, bronze, brass, sintered iron, or plastic. Preferably, hubs 5a and 5b are aluminum or steel and disk 10 is aluminum or thermoplastic.

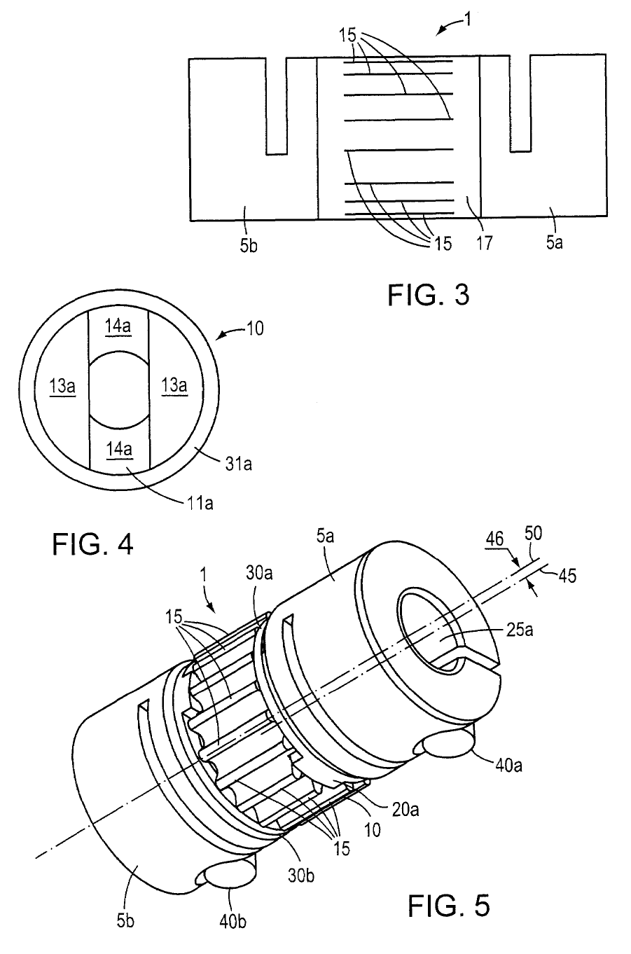

Referring to FIG. 3, hubs 5a and 5b are coupled to disk 10 as a unitary object by elastomeric material 17. Elastomeric material 17 is a rubber and capable of dampening vibrations. Elastomeric material 17 covers disk 10 and fills circumferential notches 30a and 30b, coupling hubs 5a and 5b to disk 10. Splines 15 provide for mold support yet allow elastomeric material to flow during manufacture, the space between and around each spline 15 also being filled with elastomeric material 17. In one embodiment the top edge of each spline may remain exposed to aid in centering the mold. As shown in FIG. 4, the space between surface 12a and hub 5a (not shown) is filled by a layer 13a of elastomeric material 17. Lip 31a of elastomeric material 17 is formed by elastomeric material 17 filling circumferential notch 30a of hub 5a. The space created between projection 20a and slot 11a is also filled by elastomeric material 17 creating surface 14a. Additionally, each side wall of slot 11a has a thin layer of elastomeric material 17 formed between it and projection 20a. Where slot 11a has raised surfaces 16a, the layer of elastomeric material 17 will be interrupted by such raised surfaces 16a. The space between hub 5b and surface 12b, the space between projection 20b and slot 11b, and circumferential notch 30b are filled by elastomeric material 17 in the same manner.

The elastomeric material 17 is formed around coupling 1 preferably by injection molding. Optionally, coupling 1 can be made by compression or transfer molding. When coupling 1 is fully assembled as described in the preferred embodiment, elastomeric material 17 dampens vibrations by placing naturally dampening material at interfaces of the components.

In the preferred embodiment, elastomeric material 17 can compress by about 0.010 inches, accommodating about 10 degrees of angular misalignment with displacement. Elastomeric material 17 can also stretch by 0.030 inches to accommodate 0.075 inches of radial misalignment. FIG. 5 illustrates this radial misalignment by showing coupling 1 without elastomeric material 17 for clarity. Dashed line 45 represents the axis of rotation of hub 5b while dashed line 50 is the axis of rotation of hub 5a. Double arrow 46 shows the radial misalignment between hubs 5a and 5b.

While this invention has been particularly shown and described with references to preferred embodiments thereof, it will be understood by those skilled in the art that various changes in form and details may be made therein without departing from the scope of the invention encompassed by the appended claims.

What is claimed is:

1. An Oldham coupling assembly comprising:
a first hub having a first projection;
a second hub having a second projection;
a disk having a first slot and a second slot, the slots on opposite sides and perpendicular to each other, the first projection received into the first slot and the second projection received into the second slot; and
an elastomeric material formed around the circumference of the disk to retain the assembly together.

2. The assembly according to claim 1, characterized in that the elastomeric material is overlapping a portion of each hub.

3. The assembly according to claim 1, characterized in that each hub has a circumferential notch.

4. The assembly according to claim 3, further characterized in that the elastomeric material is formed in each circumferential notch.

5. The assembly according to claim 1, characterized in that the elastomeric material is formed around the sides of the disk.

6. The assembly according to claim 1, characterized in that the disk has splines.

7. The assembly according to claim 1, characterized in that each projection is tapered.

8. The assembly according to claim 7, further characterized in that the taper is along an outer surface of each projection and extends from a flat surface in the middle of the outer surface to facilitate angular misalignment.

9. A method of making an Oldham coupling assembly, the method comprising:
joining first and second hubs to opposite sides of an intermediate disk; and
forming an elastomeric material around the circumference of the disk to retain the assembly together.

10. The method of claim 9, further comprising forming the elastomeric material over a portion of each hub.

11. The method of claim 9, further comprising forming the elastomeric material in a circumferential notch about each hub.

12. The method of claim 9, further comprising forming the elastomeric material around the sides of the disk.

13. The method of claim 9, further comprising forming the elastomeric material in a space between each hub and the disk created by each hub having a tapered projection.

14. The method of claim 9, further comprising forming the elastomeric material around splines of the disk.

15. An Oldham coupling assembly comprising:
a first hub having a first slot;
a second hub having a second slot;
a disk having a first projection and a second projection, the projections on opposite sides and perpendicular to each other, the first projection received into the first slot and the second projection received into the second slot; and
an elastomeric material formed around the circumference of the disk to retain the assembly together.

16. The assembly according to claim 15, characterized in that the elastomeric material is overlapping a portion of each hub.

17. The assembly according to claim 15, characterized in that each hub has a circumferential notch.

18. The assembly according to claim 17, further characterized in that the elastomeric material is formed in each circumferential notch.

19. The assembly according to claim 15, characterized in that the elastomeric material is formed around the sides of the disk.

20. The assembly according to claim 15, characterized in that the disk has splines.

21. The assembly according to claim 15, characterized in that each projection is tapered.

22. The assembly according to claim 21, further characterized in that the taper is along an outer surface of each projection and extends from a flat surface in the middle of the outer surface to facilitate angular misalignment.
